(19) United States
(12) Patent Application Publication
(10) Pub. No.: US 2023/0037406 A1
(43) Pub. Date: Feb. 9, 2023

(54) LEAD-FREE BRASS ALLOY AND METHOD OF USING THE LEAD-FREE BRASS ALLOY

(71) Applicant: Diehl Brass Solutions Stiftung & Co. KG, Roethenbach (DE)

(72) Inventors: Florian Seuss, Spardorf (DE); Alexander Dehnelt, Nuernberg (DE); Volker Braeutigam, Erlangen (DE)

(21) Appl. No.: 17/869,965

(22) Filed: Jul. 21, 2022

(30) Foreign Application Priority Data
Jul. 21, 2021 (DE) 10 2021 118 907.1

(51) Int. Cl. C22C 9/04

(52) U.S. Cl. CPC C22C 9/04

(57) ABSTRACT

A lead-free brass alloy contains 57.0 to 60.0% wt. Cu, 1.0 to 2.0% wt. Al, 1.5 to 2.5% wt. Mn, 0.1 to 1.0% wt. Fe, at most 0.5% wt. Ni, at most 0.5% wt. Sn, 0.5 to 2.0% wt. Si, less than 0.1% wt. Pb, balance Zn and also unavoidable impurities. Wherein the copper equivalent (CuEq) is in the range from 52.0 to 58.0%.

### CROSS-REFERENCE TO RELATED APPLICATION

This application claims the priority, under 35 U.S.C. § 119, of German Patent Application DE 102021118907.1, filed Jul. 21, 2021; the prior application is herewith incorporated by reference in its entirety.

### FIELD AND BACKGROUND OF THE INVENTION

The invention relates to a lead-free brass alloy and also to a use thereof.

U.S. Pat. No. 10,287,653 B2 discloses a lead-free brass alloy with a composition reproduced in the first claim of that patent. The known brass alloy has a zinc equivalent in the range from 51% to about 58%. The proposed brass alloy is suitable especially for producing bearings for turbochargers.

Industry requires a lead-free brass alloy suitable especially for producing parts of hydraulic pumps and hydraulic components.

### SUMMARY OF THE INVENTION

It is an object of the invention to specify a lead-free brass alloy notable for good machinability, emergency operation properties, oil compatibility and the like. The brass alloy is to be suitable especially for producing parts for hydraulic pumps and hydraulic components.

This object is achieved by the features of the independent claims.

Judicious embodiments are apparent from the features of the dependent claims.

Other features which are considered as characteristic for the invention are set forth in the appended claims.

Although the invention is illustrated and described herein as embodied in a lead-free brass alloy and a method of using the lead-free brass alloy, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DETAILED DESCRIPTION OF THE INVENTION

Proposed in accordance with the invention is a lead-free brass alloy containing 57.0 to 60.0% Cu, 1.0 to 2.0% Al, 1.5 to 2.5% Mn, 0.1 to 1.0% Fe, at most 0.5% Ni, at most 0.5% Sn, 0.5 to 2.0% Si, less than 0.1% Pb, balance Zn and also unavoidable impurities, wherein the copper equivalent (CuEq) is in the range from 52.0 to 58.0%.

The specified copper equivalent (CuEq) is calculated as follows:

### If Si_{free}=Si 3.26−(Fe+Mn)<0

a) then CuEq=Cu/{[100−Fe−Mn+(|Si_{free}|·0.7)−Al+(Al·6)−Si)]/100}

### If Si_{free}=Si·3.26−(Fe+Mn)>0

b) then CuEq=Cu/{[100−Fe−Mn−Al+(Al·6)−Si+((Si_{free}/3.26)10)]/100}
c) Cu: % copper
d) Fe: % iron
e) Al: % aluminium
f) Si: % silicon

For the purposes of the present description [%] is understood to be percent by weight.

In the above calculation of the copper equivalent CuEq, two cases, numbers 1 and 2, are distinguished. In case number 1 there is no free silicon Si_{free} in the alloy. In this case, the silicon in the alloy bonds completely with Fe and/or Mn. Intermetallic Fe—Mn—Si compounds are formed.

In case number 2 there is free silicon Si_{free} in the alloy. The distinction between the first and second cases is necessary because free silicon Si_{free} in the alloy produces a strong shift in the phase diagram in the direction of the β-phase. In this case the shift in the phase diagram in the β-phase direction is stronger by a factor of about 10 than in the case of completely bonded silicon (see calculation above, case number 1).

It has emerged that the proposed brass alloy with a copper equivalent CuEq in the 52.0 to 58.0% range exhibits frictional properties comparable with those of conventional lead-containing alloys. The proposed lead-free brass alloy is notable additionally for good machinability, emergency operation properties, oil compatibility and the like.

According to one advantageous embodiment, Si is contained in an amount of at most 1.0%. In this way a particularly suitable β-phase content is established.

According to another embodiment, Sn is contained in an amount of at most 0.2%, preferably at most 0.1%, more preferably less than 0.06%. Sn increases the relaxation resistance of the alloy.

The lead-free brass alloy proposed may contain nickel in an amount of at most 1.0%, preferably at most 0.5%. Additionally, there may be Fe contained in an amount of at most 0.5%, preferably at most 0.4%. Mn may be contained in an amount of at most 2.1%. The aforesaid elements are added for the formation of intermetallic phases in the alloy. Intermetallic phases improve the wear resistance and the ductility of the alloy.

In further accordance with the invention, a use of the lead-free brass alloy of the invention is proposed, for producing parts for hydraulic pumps and hydraulic components. The parts may be selected in particular from the following group: sliding block, distributor plate, retaining segment, and bearing bush.

What makes the proposed brass alloy especially suitable for producing parts for hydraulic pumps and hydraulic components are its good frictional properties.

According to one exemplary embodiment of the invention, the alloy of the invention has for example the following composition:

| Alloy constituent | Wt % |
|---|---|
| Cu | 57.96 |
| Al | 1.56 |
| Mn | 1.94 |
| Fe | 0.36 |
| Ni | 0.06 |
| Sn | 0.01 |
| Si | 0.59 |
| Pb | 0.02 |

The alloy having the composition indicated above exhibits the properties identified in the following table:

| | Friction |
|---|---|
| | coefficient/ |
| Properties | wear |
| Friction coefficient, lubricated | 0.11 |
| Splash lubrication in a Spirax/Fusus mixture in a | |
| ratio of 3 to 1 at 95° C. under a surface load | |
| of 52 N · mm⁻² and a rubbing velocity of | |
| 1.65 m/s in the pin-on-disc method | |
| Wear, lubricated, in km/g | 226 km/g |
| Splash lubrication in a Spirax/Fusus mixture in a | |
| ratio of 3 to 1 at 95° C. under a surface load | |
| of 52 N · mm⁻², a rubbing velocity of 1.65 | |
| m/s and a distance of 2500 m in the pin-on-disc | |
| method | |
| Friction coefficient, dry | 0.20 |
| under a surface load of 10 N · mm⁻² and | |
| a rubbing velocity of 0.55 m/s in the pin-on-disc | |
| method | |
| Wear, dry, in km/g | 121 km/g |
| under a surface load of 10 N · mm⁻² and | |
| a rubbing velocity of 0.55 m/s for 250 m in the | |
| pin-on-disc method | |

The good frictional properties of the alloy of the invention make it particularly suitable for producing hydraulic pumps and hydraulic components, more particularly sliding blocks, distributor plates, retaining segments and bearing bushes.

1. A lead-free brass alloy, comprising:
57.0 to 60.0% wt. Cu,
1.0 to 2.0% wt. Al,
1.5 to 2.5% wt. Mn,
0.1 to 1.0% wt. Fe,
at most 0.5% wt. Ni,
at most 0.5% wt. Sn,
0.5 to 2.0% wt. Si,
less than 0.1% wt. Pb,
balance Zn;
unavoidable impurities; and
wherein a copper equivalent (CuEq) is in a range from 52.0 to 58.0%.

2. The lead-free brass alloy according to claim 1, wherein said Si is in an amount of at most 1.0% wt.

3. The lead-free brass alloy according to claim 1, wherein said Sn is in an amount of less than 0.2% wt.

4. The lead-free brass alloy according to claim 1, wherein said Ni is in an amount of at most 1.0% wt.

5. The lead-free brass alloy according to claim 1, wherein said Fe is in an amount of at most 0.5% wt.

6. The lead-free brass alloy according to claim 1, wherein said Mn is in an amount of at most 2.1% wt.

7. The lead-free brass alloy according to claim 1, wherein said Sn is in an amount of at most 0.1% wt.

8. The lead-free brass alloy according to claim 1, wherein said Sn is in an amount of less than 0.06% wt.

9. The lead-free brass alloy according to claim 1, wherein said Ni is in an amount of at most 0.5% wt.

10. The lead-free brass alloy according to claim 1, wherein said Fe is in an amount of at most 0.4% wt.

11. A method for producing goods, which comprises:
producing parts for hydraulic pumps and hydraulic components using the lead-free brass alloy produced according to claim 1.

12. The method according to claim 11, which further comprises selecting the parts from the group consisting of: sliding blocks, distributor plates, retaining segments, and bearing bushes.
